(19) United States
(12) Patent Application Publication
(10) Pub. No.: US 2018/0134925 A1
(43) Pub. Date: May 17, 2018

(54) HIGH TEMPERATURE RESISTANT PRESSURE SENSITIVE ADHESIVE WITH LOW THERMAL IMPEDANCE

(71) Applicant: Polyonics, Inc., Westmoreland, NH (US)

(72) Inventors: Delilah F. Adams, Keene, NH (US); Robert H. Guyette, JR., Sullivan, NH (US); Donald P. Nieratko, Hancock, NH (US)

(21) Appl. No.: 15/807,839

(22) Filed: Nov. 9, 2017

Related U.S. Application Data
(60) Provisional application No. 62/420,761, filed on Nov. 11, 2016.

(51) Int. Cl. C09J 9/00; C09J 11/04; C09J 183/04; C09J 7/02; C09K 5/14

(52) U.S. Cl. CPC C09J 9/00; C09J 11/04; C09J 183/04; C09J 7/0207; C09J 7/0292; C09J 2479/086; C09J 7/0282; C09K 5/14; C09J 2483/00; C09J 2400/163; C09J 2400/10; C09J 7/026

(57) ABSTRACT

A high temperature resistant thermally conductive pressure sensitive adhesive composition comprising a first silicon resin, a second silicon resin, a first thermally conductive filler, a second thermally conductive filler, a catalytically effective amount of a curing agent, an optional defoaming agent, and an optional drying agent, wherein said thermally conductive filler has a volume weighted mean particle size in the range of 8 to 20 μm.

### CROSS REFERENCE TO RELATED APPLICATION

This application claims the priority benefit of U.S. provisional application No. 62/420,761, filed Nov. 11, 2016. The aforementioned application is incorporated herein by reference in its entirety.

### BACKGROUND

The present invention relates to pressure sensitive adhesives and, in particular, to silicone pressure sensitive adhesive materials using thermally conductive fillers useful to provide an adhesive thermal interface material with low thermal impedance that can be used at high operating temperatures.

The reliability of electronic systems or components thereof, such as circuit boards, power supplies, batteries, integrated circuits, semiconductor devices, LED devices such as LED lighting devices, and so forth, is directly related to the amount of temperature stress such devices or components are exposed to.

There is a relationship between reliability and a system's failure rate, as expressed by the Arrhenius Model that states that failure rate is a function of temperature stress such that the higher the temperature stress, the higher the failure rate. Typically, every 10° C. rise in operating temperature causes a 50% increase in failure rate. Conversely, cutting the operating temperature by 10° C. reduces the failure rate by 50%.

Thermally conductive silicone, e.g., thermal grease, having suspended thermally conductive particles are known for use in heat transfer applications, but lack adhesion. Thermally conductive silicone pads are known that can produce high thermal conductivity but they do not have the same conformability and adhesion as a pressure sensitive adhesive. See, for example, U.S. Pat. No. 5,679,457 and U.S. Patent Application Publication No. 2013/0148303. Silicone pads do not conform as well to surfaces. Air gaps between the pad and the mating surfaces will increase thermal resistance. Pads that are exposed to high operating temperatures can “dry out” and crack or shrink, which will increase thermal resistance even more.

U.S. Pat. No. 6,315,038 discloses the use of a non-thermally conductive pressure sensitive adhesive to attach a thermal cooling device to an integrated circuit package. Since the adhesive is not thermally conducting, the adhesive is applied outside of the thermal transfer area and separate thermal interface material is required at the thermal interface.

Acrylic thermally conductive pressure sensitive adhesives are also known in the art, but tend to degrade at high temperatures.

The present disclosure contemplates an improved thermally conductive silicone pressure sensitive adhesive material for use as a thermal interface material between temperature sensitive electronic components and a heat sink or other cooling or heat dissipation device (e.g., heat spreader plate, heat pipes, thermoelectric coolers, Peltier coolers, etc.) and which has an improved resistance to high temperatures. The present invention also contemplates methods for conducting heat away from temperature sensitive components employing the pressure sensitive adhesive materials in accordance with this disclosure. The present invention also contemplates articles of manufacture such as single-sided or double-sided adhesive tape employing the pressure sensitive adhesive materials in accordance with this disclosure.

### SUMMARY

In one aspect, a high temperature resistant thermally conductive pressure sensitive adhesive composition is provided, which comprises a first silicon resin, a second silicon resin, a first thermally conductive filler, a second thermally conductive filler, a catalytically effective amount of a curing agent, an optional defoaming agent, and an optional drying agent, wherein said thermally conductive filler has a volume weighted mean particle size in the range of 8 to 20 μm.

In another aspect, a high temperature resistant thermally conductive pressure sensitive adhesive tape construction is provided.

In a more limited aspect, an unsupported tape construction comprising a high temperature resistant thermally conductive pressure sensitive adhesive tape removably laminated to at least one release liner is provided.

In another more limited aspect, an unsupported tape construction comprising a high temperature resistant thermally conductive pressure sensitive adhesive tape removably laminated between two release liners is provided.

In another more limited aspect, a single sided tape construction is provided comprising a high temperature resistant thermally conductive pressure sensitive adhesive tape having a first major surface aggressively laminated to a thermally conductive backing layer. Optionally, a release liner is removably laminated to a second major surface of the high temperature resistant thermally conductive pressure sensitive adhesive.

In yet another more limited aspect, a double sided tape construction is provided comprising a thermally conductive backing layer and a first high temperature resistant thermally conductive pressure sensitive adhesive layer aggressively laminated to a first major surface of the thermally conductive backing layer and a second high temperature resistant thermally conductive pressure sensitive adhesive layer aggressively laminated to a second major surface of the thermally conductive backing layer. Optionally, a release liner is removably laminated to the outward facing surfaces of each of the first and second high temperature resistant thermally conductive pressure sensitive adhesive layers.

In another aspect, a method for making a laminated tape construction is provided.

In still another aspect, a method for conducting heat from a heat-generating electronic component to a heat sink or other cooling device is provided.

One advantage of the adhesive compositions of the present development is found in its increased resistance to high temperatures than other thermally conductive adhesives, such as acrylic-based thermally conductive adhesives. Acrylic adhesives will degrade above 125° C.

Another advantage of the adhesive compositions of the present development resides in their low thermal impedance and/or high thermal conductivity. While silicone resins can be used at operating temperatures up to 175° C. and above, the high temperature resistant thermally conductive pressure sensitive adhesives in accordance with the present disclosure have lower thermal impedance and/or higher thermal conductivity than most thermally conductive acrylic and silicone adhesives.

Still another advantage of the adhesive compositions of the present development is their ability to resist degradation when exposed to high temperatures. It has been found that important properties such as thermal conductivity, adhesion, and shear resistance of the presently disclosed adhesives do not degrade, and in some instances may improve, after exposure to high operating temperatures.

Another advantage that the presently disclosed adhesive has over some acrylic pressure sensitive adhesives is that it does not burn. This presently disclosed adhesives are non-flammable because they use silicone resins which do not burn.

Still another advantage of certain embodiments of the present development resides in the ability to provide an adhesive composition having a unique combination of the following properties: (1) low thermal resistance, (2) high temperature resistance, (3) high adhesion strength, and (4) meet UL94 V-0 flammability test requirements. Some adhesives can have 1 or 2 of these properties but it is difficult to achieve all of these properties.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings, which are not necessarily to scale, are only for purposes of illustrating preferred embodiments and are not to be construed as limiting the invention.

FIG. 1 is side view of a sheet of a high temperature resistant thermally conductive pressure sensitive adhesive in accordance with a first exemplary embodiment of the present disclosure.

FIG. 2 is side view of a sheet of a high temperature resistant thermally conductive pressure sensitive adhesive in accordance with a second exemplary embodiment of the present disclosure.

FIG. 3 is side view of a sheet of a high temperature resistant thermally conductive pressure sensitive adhesive in accordance with a third exemplary embodiment of the present disclosure.

FIG. 4 is side view of a sheet of a high temperature resistant thermally conductive pressure sensitive adhesive in accordance with a fourth exemplary embodiment of the present disclosure.

FIG. 5 is a graph illustrating thermal conductivity of single and double sided tape employing the high temperature resistant thermally conductive pressure sensitive adhesive in accordance with this disclosure after one week at 175° C.

FIG. 6 is a graph illustrating 180-degree peel adhesion of single and double sided tape employing the high temperature resistant thermally conductive pressure sensitive adhesive in accordance with this disclosure after one week at 175° C.

FIG. 7 is a graph illustrating lap shear of single and double sided tape employing the high temperature resistant thermally conductive pressure sensitive adhesive in accordance with this disclosure after one week at 175° C.

FIG. 8 is a graph of particle size distribution of an exemplary high temperature resistant thermally conductive pressure sensitive adhesive in accordance with this disclosure.

FIG. 9 is a table of the particle size analysis data for the graph appearing in FIG. 8.

### DETAILED DESCRIPTION OF THE PREFERRED EMBODIMENTS

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). All percentages or ratios recited herein are by weight unless staged otherwise.

A high temperature resistant thermally conductive pressure sensitive adhesive comprises a polysiloxane polymer reaction product of at least two silicone resins and two or more thermally conductive fillers having a volume weighted mean particle size in the range of 8 μm to 20 μm.

An exemplary high temperature resistant thermally conductive pressure sensitive adhesive in accordance with the present disclosure includes:

1. Two or more silicone resins

2. Two or more thermally conductive fillers

3. A curing agent

4. A dispersing agent

5. An optional defoamer

6. An optional drying agent/water scavenger

Exemplary silicone resins include a siloxane gum and an MQ tackifying resin.

In presently preferred embodiments, the high temperature resistant thermally conductive pressure sensitive adhesive includes first and second silicone resins, wherein the first silicone resin is a phenyl based siloxane gum and the second silicone resin is a silicate tackifying resin.

In certain embodiments, the first silicone resin is added to the reaction mixture at an amount of 55 to 75% by weight, or more preferably 60% to 70% by weight, based on the finished dry adhesive that the customer uses, i.e., exclusive of solvents, as described below.

In certain embodiments, the second silicone resin is added to the reaction mixture at an amount of 4 to 12%, or more preferably 7 to 10% by weight of the reaction mixture.

An exemplary commercially available silicone resin suitable for use as the first silicone resin is PSA518 from available from Momentive Performance Materials of Waterford, N.Y. A commercially available silicone resin suitable for use as the second silicone resin is SR545 available from Momentive Performance Materials of Waterford, N.Y.

Exemplary thermally conductive fillers include metals, metal oxides, ceramics, carbon materials, inorganic materials, or other suitable materials. Combinations of such materials are also suitable. Suitable metals include, for example, aluminum, copper, silver, nickel, magnesium, and brass. Suitable metal oxides include, for example, alumina, magnesium oxide, zinc oxide, and titanium oxide. Suitable inorganic and/or ceramic materials include, for example, boron nitride, aluminum nitride, silicon carbide, silicon nitride, boron carbide, titanium diboride, titanium carbide, and aluminum silicon carbide. Suitable carbon materials include various grades of graphite, diamond powder, carbon nanotubes, carbon black, and the like.

The thermally conductive fillers can be in the form of flakes, powders, needles, fibers, spherical particles, and so forth, or agglomerates of these shapes. In preferred embodiments, the thermally conductive fillers are irregularly shaped flakes. The thermally conductive filler is added to the reaction mixture. In certain embodiments, the thermally conductive filler includes a mixture of graphite and boron nitride. In preferred embodiments, graphite thermally conductive filler is added to the reaction mixture at an amount of 5 to 18% by weight of the final product, or more preferably 10 to 14% by weight of the final product, and boron nitride thermally conductive filler is added to the reaction mixture at an amount of 5 to 18% by weight of the final product, or more preferably 10 to 14% by weight of the final product.

A commercially available graphite product suitable for use as the thermally conductive filler is G3775, available from Asbury Carbons of Asbury, N.J. A commercially available boron nitride product suitable for use as the thermally conductive filler is PCTP16, available from Saint-Gobain of Amherst, N.Y.

In certain embodiments, a catalyst or curing agent is also added to the reaction mixture in a catalytically effective amount. In certain embodiments, the curing agent is a peroxide curing agent, such as benzoyl peroxide, 2,4-dichlorobenzoyl peroxide, or the like. In preferred embodiments, the curing agent is benzoyl peroxide. In certain embodiments, benzoyl peroxide is added to the reaction mixture in an amount of 0.1% to 3%, preferably 0.2 to 1% by weight in the final product.

In certain embodiments, a dispersing agent is also added to the reaction mixture to help disperse the thermally conductive materials in the composition. In certain embodiments, the dispersing agent is added to the reaction mixture in an amount of 0.1% to 4%, preferably 0.5% to 1.5% by weight in the final product. By way of non-limiting example, a suitable dispersing agent is DISPERBYK-108, available from Byk-Gardener GmbH of Geretsried, Germany. Other suitable dispersing agents include LDA 100 available from Lorama of Cleveland, Ohio, and EFKA 5207 available from BASF of Charlotte, N.C.

In certain embodiments, an optional defoamer is added to the reaction mixture to help control or eliminate foam or trapped air in the reaction mixture. In certain embodiments, the defoamer is added to the reaction mixture in an amount of 0.001% to 0.1%, preferably 0.01 to 0.09% by weight of the final product. By way of non-limiting example, a suitable defoamer is BYK-066 N available from Byk-Chemie GmbH of Wesel, Germany. Other defoamers such as BYK-070 and BYK-054 can be used from Byk-Chemie. In certain embodiments, the defoamer is omitted, e.g., if a manufacturing process is used that does not induce foam in the reaction mixture.

In certain embodiments, a water scavenger or drying agent is also added to the adhesive reaction mixture to reduce foam while milling the adhesive. In certain embodiments, the water scavenger is added to the reaction mixture in an amount of 0.05% to 0.25%, preferably 0.1% to 0.2% by weight of the final product. Exemplary water scavengers include molecular sieves, silanes, activated neutral alumina, silica, or other drying agents known to persons skilled in the art to remove water from solvent based adhesives. In certain embodiment, the water scavenger is SILIPORITE 3A molecular sieves available from Quanex IG Systems of Cambridge, Ohio.

In certain embodiments, the particle size distribution of the thermally conductive fillers in the final adhesive, i.e., after milling (as described in greater detail below), is a normal distribution. In certain embodiments, the volume weighted mean particle size in the range of 8 to 20 μm as determined by laser diffraction. In preferred embodiments, the particle size distribution of the thermally conductive fillers in the final adhesive is a normal distribution with a volume weighted mean particle size in the range of 10 to 14 μm as determined by laser diffraction.

In certain embodiments, the thermally conductive fillers have a size distribution d(0.1) of from 2 to 4 μm. In further embodiments, the thermally conductive fillers have a size distribution d(0.5) of from 8 to 12 μm. In still further embodiments, the thermally conductive fillers have a size distribution d(0.9) of from 22 to 27 μm. In certain embodiments, the thermally conductive fillers have an overall particle size range of from 5 to 75 μm. It will be recognized that the volume weighted mean and the d(0.1), d(0.5), and d(0.9) size distributions of the thermally conductive fillers may vary outside of the ranges above, but typically fall within 2 to 4 μm, 8 to 12 μm, 22 to 27 μm, respectively.

The high temperature resistant thermally conductive pressure sensitive adhesive in accordance with this disclosure is manufactured using one or more solvents so that the adhesive is easy to apply in a thin film. The adhesive is then dried in an oven or dryer to provide a final pressure sensitive adhesive product. In certain embodiments, the solvent is an organic solvent. Exemplary solvents include toluene, xylene, methyl ethyl ketone (MEK), and the like, although the use of other solvents to dilute the adhesive prior to drying in a thin film is also contemplated.

Any number of techniques may be employed to prepare the high temperature resistant thermally conductive pressure sensitive adhesive compositions of the presently disclosed development, as within the knowledge of one skilled in the art. The pressure sensitive adhesive compositions according to the present disclosure may advantageously be prepared using a mixing device, such as an electrically operated mixing device equipped with a standard mixing propeller. In certain embodiments, the mixing device is equipped with a Cowles blade.

In a first step, the silicone resins, thermally conductive fillers, curing agent, dispersing agent, and optional defoamer and drying agent are combined and mixed with a propeller, Cowles blade, or the like. Preferably, the dispersing agent (e.g., DISPERBYK-108) is added to the reaction mixture prior to adding the thermally conductive fillers (e.g., boron nitride and graphite). The defoamer (e.g., BYK-066 N) and drying agent (e.g., SILIPORITE 3A) should be added after the thermally conductive fillers. The curing agent (e.g., benzoyl peroxide) should be added to the mixture a day before or the day of coating because the benzoyl peroxide can degrade and thus become less able to cure the adhesive over time.

In a second step, the viscosity of the reaction mixture produced in step 1 above is reduced with a solvent to provide a reduced viscosity mixture. The quantity of solvent used is a quantity of solvent to produce a reduced viscosity mixture having a viscosity in the range of 300 cps to 20,000 cps, and preferably in the range of 2000 cps to 10,000 cps.

In a third step, the reduced viscosity mixture produced in step 2 above is passed through a mill to reduce the particle size of the thermally conductive fillers to the particle size desired in the final adhesive composition. Exemplary mills suitable for reducing the particle size of the thermally conductive fillers include bead mills, three roll mills, rotor stator mills, or other devices capable of applying a high shearing force.

In a fourth step, a thin film of the reduced viscosity mixture is applied to a removable release liner. The release liner includes a liner substrate such as a paper, polymer film, or other suitable sheet of material. At least one of the major surfaces of the release liner, i.e., the release surface, is treated with a release agent, such as a silicone or fluorosilicone release agent. The release liner supports the thin film of the reduced viscosity mixture while still allowing the adhesive to be readily removed therefrom. Exemplary coating methods for applying the thin film to the release liner include wire rod, knife-over-roll, reverse roll, gravure (including reverse gravure, direct gravure, and offset gravure, extrusion die, slot die, curtain coating techniques, and the like. In certain embodiments, the reduced viscosity coating has a thickness of 1.25 to 50 mils, preferably, 2.5 to 25 mils, which yields an adhesive thickness in the final, dried pressure sensitive adhesive in the range of 0.5 to 20 mils, preferably 1 to 10 mils.

In a fifth step, the coated release liner is passed through a drying oven to remove the solvent. The resulting laminated construction comprises the final high temperature resistant thermally conductive pressure sensitive adhesive removably supported on the release liner. In certain embodiments, the laminate may be cut to a desired length and width. In certain embodiments, the laminate may be packaged as rolls having a desired width and length.

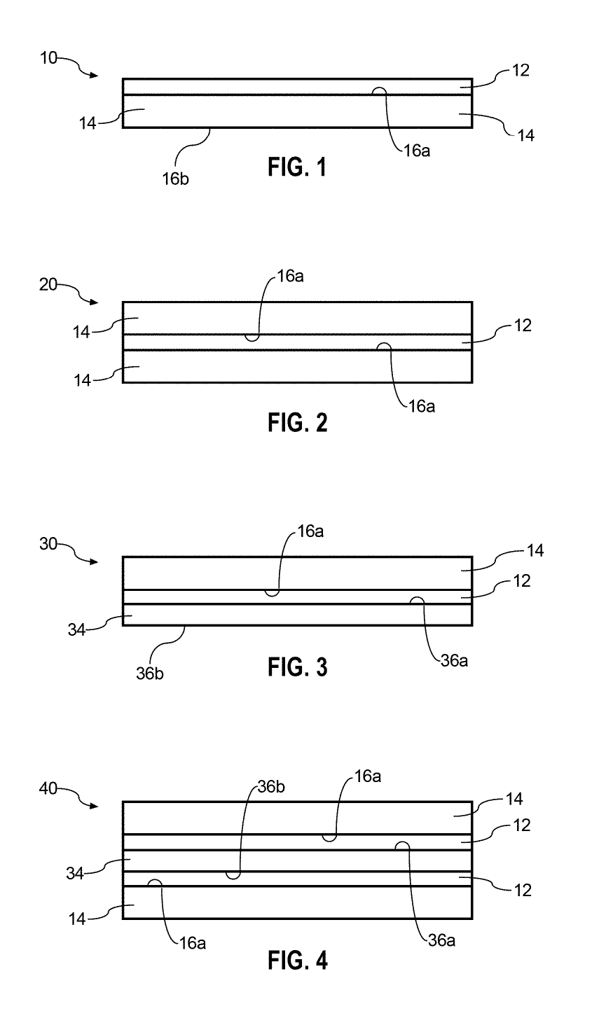

FIGS. 1-4 illustrate exemplary tape constructions employing the high temperature resistant thermally conductive pressure sensitive adhesive according to the present development. In the illustrated side views of FIGS. 1-4, the edges of the adhesive layer are aligned with the edges of the associated backing layer(s) in the dimension shown. In certain embodiments, one or more edges of the release layer may optionally extend beyond an edge of the adhesive layer to facilitate removal of the backing layer from the adhesive layer during application.

A side view of a first exemplary laminated construction 10 appears in FIG. 1. The laminated construction 10 includes an adhesive layer 12 and a release liner 14, wherein at least the surface 16a has been treated with a release agent. The laminated construction 10 may be used as a so-called transfer tape which does not have a backing layer, e.g., to provide a thermal connection or interface between a heat generating electronic component and a heat sink or other cooling device. In certain embodiments, the surface 16b may also be treated with a release agent, wherein the laminated construction 10 can be packaged as a roll such that the adhesive layer 12 does not aggressively adhere to the surface 16b.

A side view of a second exemplary laminated construction 20 appears in FIG. 2. The laminated construction 20 includes an adhesive layer 12 between two release liners 14, wherein at least the surface 16a of each release liner has been treated with a release agent. The laminated construction 20 may be used as a transfer tape which does not have a backing layer, e.g., to provide a thermal connection or interface between a heat generating electronic component and a heat sink or other cooling device. The laminated construction 20 can be packaged as sheets or rolls of desired length and width.

A side view of a third exemplary laminated construction 30 appears in FIG. 3. The laminated construction 30 includes an adhesive layer 12 aggressively attached to a first surface 36a of a thermally conductive backing or carrier film 34. The thermally conductive carrier film 34 may be, for example, aluminum foil, graphite films, polyimide films with thermally conductive filler, or the like. The carrier film may be selected to impart a desired property to the laminated construction 30. For example, a backing layer 34 formed of aluminum foil can import tensile strength to the tape construction as well as extra thermal conductivity. A backing layer 34 formed of a polyimide film with thermally conductive fillers can increase thermal conductivity and provide electrical insulation through the construction.

Optionally, the surface 36a of the backing layer 34 can be treated to increase delamination resistance between the adhesive layer 12 and the backing layer 34. Exemplary treatments include coating the surface 36a with a primer substance or subjecting the surface 36a to a physical treatment such as corona treatment or flame treatment. Optionally, the laminated construction 30 further includes a release liner 14, wherein at least the surface 16a has been treated with a release agent to protect the adhesive layer prior to use. The laminated construction 30 can be packaged as sheets or rolls of desired length and width. In certain embodiments, the release liner 14 can be omitted and the non-adhesive surface 36b of the carrier film 34 can be treated with a release agent, such as a silicone or fluorosilicone release agent, to prevent the adhesive layer 12 from aggressively adhering to the surface 36b of the carrier film when the laminated construction 30 is packaged as a roll.

A side view of a fourth exemplary laminated construction 40 appears in FIG. 4. The laminated construction 40 includes a first adhesive layer 12 aggressively attached to a first surface 36a of a thermally conductive backing or carrier film 34 and a second adhesive layer 12 aggressively attached to a second surface 36b of a thermally conductive backing or carrier film 34, as described above. Optionally, one or both of the surfaces 36a and 36b of the backing layer 34 can be treated to increase delamination resistance between the adhesive layers 12 and the backing layer 34. Exemplary treatments include coating the surfaces 36a, 36b with a primer substance or subjecting the surfaces 36a, 36b to a physical treatment such as corona treatment or flame treatment. The laminated construction 30 further includes first and second release liners 14, wherein at least the surface 16a of each release liner 14 has been treated with a release agent to protect the adhesive layer 12 prior to use. The laminated construction 40 can be packaged as sheets or rolls of desired length and width.

The following examples describe preferred embodiments of the present compositions and should not be interpreted as limiting the scope of the invention.

### Example 1

A high temperature resistant thermally conductive pressure sensitive adhesive composition of this disclosure was prepared using the following ingredients:

TABLE 1

| | Wet Weight | Dry Weight % in |
|---|---|---|
| Ingredient | Percent | final product |
| Toluene | 16.0% | |
| Silicate tackifying resin | 6.5% | 8.6% |
| DISPERBYK-108 | 0.41% | 0.9% |
| Graphite | 5.9% | 12.9% |
| Boron nitride | 5.9% | 12.9% |
| BYK-066 N | 0.02% | 0.06% |
| Molecular sieves | 0.06% | 0.14% |
| Phenyl based siloxane gum | 49.1% | 64.2% |
| Toluene | 16.0% | |
| Benzoyl peroxide | 0.11% | 0.3% |

The volume D50 particle size of the graphite and boron nitride in the reaction mixture prior to milling were 8 and 16 μm, respectively, as determined by laser diffraction. The largest particles of each filler are 4 times larger than the average.

The reaction mixture was prepared by blending together all of the ingredients using an electric mixer equipped with a Cowles blade to form a homogeneous composition. The reduced viscosity mixture was then milled using a Ross Rotor Stator mill.

The milled composition described above was then coated onto a fluorosilicone treated release liner using a 3 roll reverse roll technique at 3 to 8 mils thick and dried in a roll to roll process through ovens with increasing oven settings from 230° F. (110° C.) to 365° F. (185° C.) to produce a high temperature resistant thermally conductive pressure sensitive adhesive in accordance with this disclosure having a thickness of 1.5 to 3 mils.

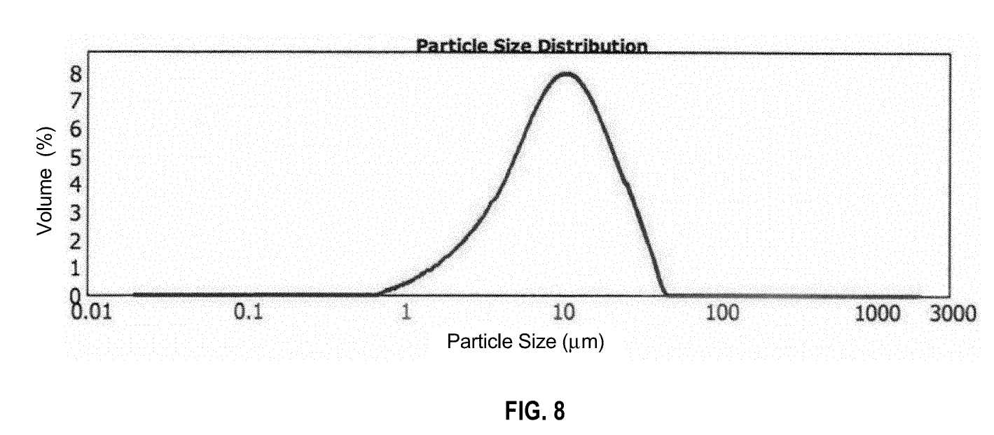

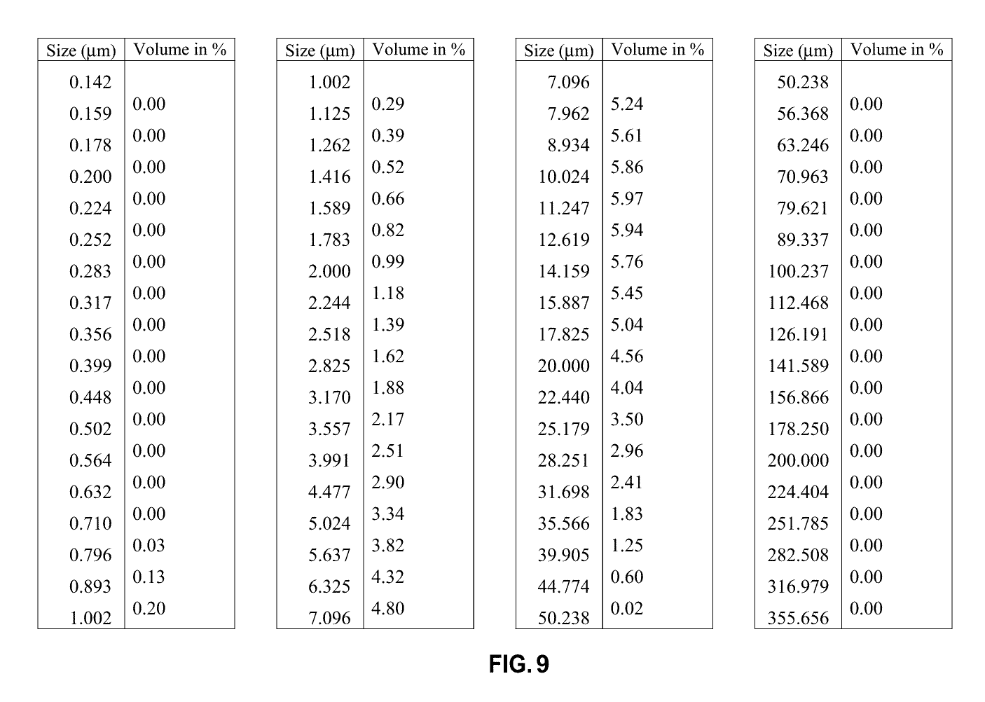

The particle size distribution of the thermally conductive filler in the final dried adhesive was analyzed using laser diffraction and was found to have a specific surface area of 0.906 m²/g, a surface weighted mean diameter D[3,2] of 6.621 μm, and a volume weighted mean diameter D[4,3] of 12.057 μm. At d(0.1), i.e., the 10th percentile, 10% of the volume of thermally conductive particles have a diameter of 3.152 μm or lower; at d(0.5), i.e., the 50th percentile, 50% of the volume of thermally conductive particles have a diameter of 9.894 μm or lower, and at d(0.9), i.e., the 90th percentile, 90% of the volume of thermally conductive particles have a diameter of 24.371 or lower. The thermally conductive filler in the final dried adhesive had an overall particle size range of about 0.8 to 50 μm. A graph of the particle size distribution appears in FIG. 8 and a table showing the size and volume data appears in FIG. 9.

The 3 mil pressure sensitive adhesive so produced was then tested for thermal conductivity and thermal impedance using ASTM D5470 and the results are shown in Table 2 below along with comparative thermal conductivity and thermal impedance from the supplier technical data sheets for several commercially available pressure sensitive adhesives. The thermally conductive adhesive has a higher thermal conductivity and lower thermal impedance than most competitive materials.

TABLE 2

| | Thermal | Thermal |
|---|---|---|
| | Conductivity | Impedance |
| Adhesive | (W/m-K) | (in²-K/W) |
| 1.5 TO 3 MIL ADHESIVE | >0.6 | <0.35 |
| BERGQUIST BOND-PLY 400 | 0.4 | 0.87 |
| BERGQUIST BOND-PLY 660P | 0.4 | 0.8 |
| ADHESIVE RESEARCH 8043 | 0.34 | 0.22 |
| AVERY DENNISON FT1224 | 0.5 | No Data |
| PARKER CHOMERICS T404 | 0.4 | 0.6 |

### Example 2

The thermally conductive pressure-sensitive adhesive obtained in Example 1 was used to prepare a single sided adhesive tape and a double sided adhesive tape. The single sided adhesive tape was prepared by applying the thermally conductive pressure-sensitive adhesive obtained in Example 1 to one major surface of DUPONT™ KAPTON® MT+ polyimide film, available from E. I. du Pont de Nemours and Company of Wilmington, Del. The double sided adhesive tape was prepared by applying the thermally conductive pressure-sensitive adhesive obtained in Example 1 to both major surface of DUPONT™ KAPTON® MT+ polyimide film.

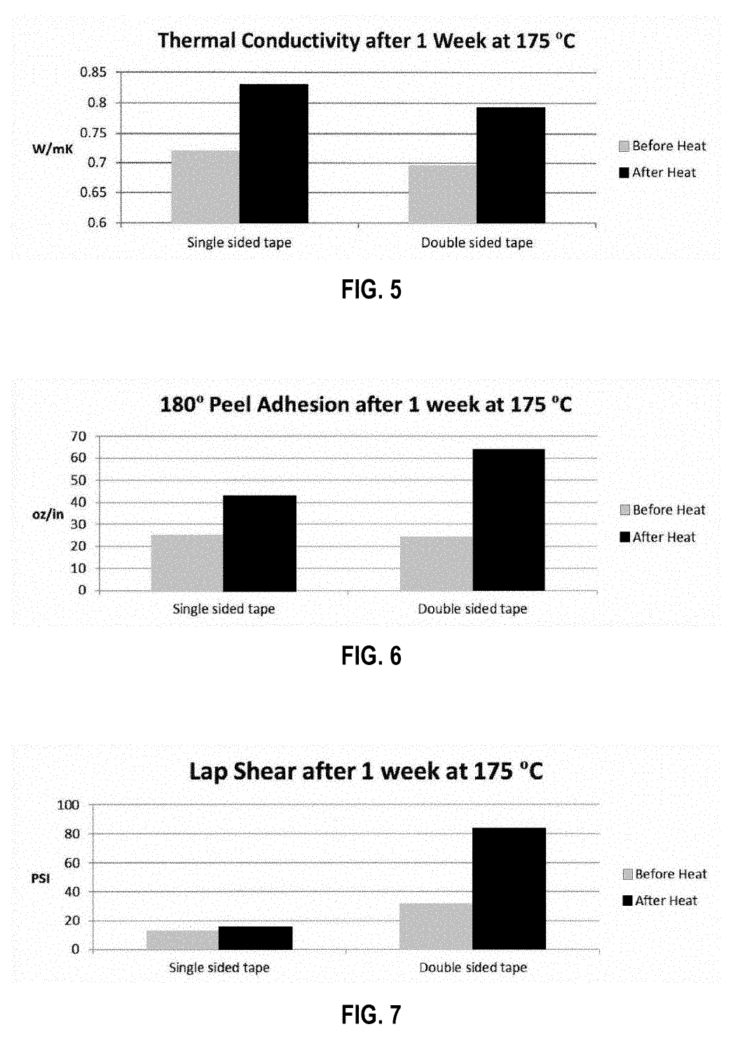

The single sided adhesive tape and the double sided adhesive tape produced were tested for thermal conductivity before heating using ASTM D5470. The single sided adhesive tape and the double sided adhesive tape were then heated to 175° C. for 1 week and allowed to cool to room temperature for one day before testing for thermal conductivity using ASTM D5470. The thermal conductivity test results for the single and double sided tape before and after heating appear in FIG. 5.

The single sided adhesive tape and the double sided adhesive tape were also tested for 180-degree peel adhesion before heating using ASTM D3330. The single sided adhesive tape and the double sided adhesive tape were also heated to 175° C. for 1 week and allowed to cool to room temperature for one day before testing for 180 degree peel adhesion using ASTM D3330. The test results for the 180 degree peel adhesion tests for the single and double sided tapes before and after heating appear in FIG. 6.

The single sided adhesive tape and the double sided adhesive tape were also tested for lap shear before heating using ASTM D1002. The single sided adhesive tape and the double sided adhesive tape were then heated to 175° C. for 1 week and allowed to cool to room temperature for one day before testing for lap shear using ASTM D1002. The test results for the lap shear tests for the single and double sided tapes before and after heating appear in FIG. 7.

FIGS. 5-7 show that these properties do not degrade when the adhesive is laminated to a carrier film such as a thermally conductive polyimide film and exposed to 175° C. for 1 week. In contrast, acrylic pressure sensitive adhesives severely degrade after exposure to 175° C. for a week.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims and their equivalents.

What is claimed is:

1. A high temperature resistant thermally conductive pressure sensitive adhesive composition, comprising:
two or more silicon resins;
two or more thermally conductive fillers; and
a catalytically effective amount of a curing agent;
wherein said two or more thermally conductive fillers have a volume weighted mean particle size in the range of 8 to 20 μm.

2. The composition of claim 1, wherein the first silicone resin is a phenyl based siloxane gum and the second silicone resin is a silicate tackifying resin.

3. The composition of claim 1, wherein the thermally conductive fillers are selected from the group consisting of a metal, aluminum, copper, silver, nickel, magnesium, and brass, metal oxide, alumina, magnesium oxide, zinc oxide, titanium oxide, ceramic, inorganic material, boron nitride, aluminum nitride, silicon carbide, silicon nitride, boron carbide, titanium diboride, titanium carbide, and aluminum silicon carbide, carbon material, graphite, diamond powder, carbon nanotubes, carbon black, and combinations thereof.

4. The composition of claim 1, wherein the thermally conductive filler is a mixture of graphite and boron nitride.

5. The composition of claim 4, wherein the graphite is present in the range of about 5 to about 18% by weight and the boron nitride is present in the range of about 5 to about 18% by weight.

6. The composition of claim 1, further comprising one or more of a defoaming agent, a drying agent, and a dispersing agent.

7. The composition of claim 1, wherein the curing agent is selected from the group consisting of benzoyl peroxide and 2,4-dichlorobenzoyl peroxide

8. The composition of claim 1, wherein the particle size distribution of the two or more thermally conductive fillers is a normal distribution with a volume weighted mean particle size in the range of 10 to 14 μm as determined by laser diffraction.

9. The composition of claim 1, wherein the two or more thermally conductive fillers have a size distribution d(0.1) of from 2 to 4 μm, a size distribution d(0.5) of from 8 to 12 μm, and a size distribution d(0.9) of from 22 to 27 μm.

10. A high temperature resistant thermally conductive pressure sensitive adhesive tape construction, comprising:
a substrate having a first major surface and a second major surface opposite the first major surface; and
a first pressure sensitive adhesive layer disposed on the first major surface, the first pressure sensitive adhesive layer being formed of a pressure sensitive composition, the pressure sensitive adhesive composition comprising two or more silicon resins, two or more thermally conductive fillers, and a catalytically effective amount of a curing agent, wherein said two or more thermally conductive fillers have a volume weighted mean particle size in the range of 8 to 20 μm.

11. The tape construction of claim 10, wherein the substrate is a tape backing layer aggressively attached to the first pressure sensitive layer.

12. The tape construction of claim 11, further comprising:
a second pressure sensitive adhesive layer disposed on the second major surface, the second pressure sensitive adhesive layer being formed of the pressure sensitive composition.

13. The tape construction of claim 11, wherein the backing layer is a thermally conductive film.

14. The tape construction of claim 13, wherein the thermally conductive film is selected from the group consisting of aluminum foil, graphite film, and a polyimide film having a thermally conductive material dispersed therein.

15. The tape construction of claim 14, further comprising one or both of:
a first release liner removably laminated to an outward facing surface of the first pressure sensitive adhesive layer; and
a second release liner removably laminated to an outward facing surface of the second pressure sensitive adhesive layer.

16. The tape construction of claim 11, further comprising a release liner removably attached to the pressure sensitive adhesive layer.

17. The tape construction of claim 10, wherein the substrate is a first release liner releasably attached to a first surface of the first pressure sensitive layer.

18. The tape construction of claim 17, further comprising a second release liner releasably attached to a second surface of the first pressure sensitive layer opposite the first surface of the first pressure sensitive layer.

19. A method for making a tape construction comprising a pressure sensitive adhesive laminated to a substrate, comprising:
forming a pressure sensitive adhesive reaction mixture by admixing two or more silicon resins, two or more thermally conductive fillers, and a catalytically effective amount of a curing agent;
adding a solvent to the reaction mixture to provide a reduced viscosity mixture;
milling the reduced viscosity mixture to reduce the particle size of the two or more thermally conductive fillers, wherein the two or more thermally conductive fillers have a volume weighted mean particle size in the range of 8 to 20 μm to provide a reduced particle size mixture;
applying a thin film of the reduced particle size mixture to the substrate to provide a coated substrate;
drying the coated substrate to remove the at least a portion of the solvent from the reduced viscosity mixture.

20. The method of claim 19, wherein the substrate is a tape backing layer and the pressure sensitive adhesive is aggressively laminated to the substrate.

21. The method of claim 20, wherein the tape backing layer is a thermally conductive film.

21. The method of claim 19, wherein the substrate is a release liner and the pressure sensitive adhesive is releasable laminated to the substrate.

23. The method of claim 22, wherein the substrate is treated with a release agent.

24. The method of claim 19, further comprising adding one or more additives selected from the group consisting of a defoaming agent, a drying agent, and a dispersing agent to the reaction mixture.

25. The method of claim 19, further comprising one or both of:
adding a dispersing agent is to the reaction mixture prior to adding the two or more thermally conductive fillers to the reaction mixture; and
adding one or both of a defoaming agent and a drying agent after adding the two or more thermally conductive fillers to the reaction mixture.

26. The method of claim 19, wherein the reduced viscosity mixture has a viscosity in the range of 300 cps to 20,000 cps.
